(19) United States
(12) Patent Application Publication
(10) Pub. No.: US 2018/0183226 A1
(43) Pub. Date: Jun. 28, 2018

(54) CABLE FIXTURE

(71) Applicant: HIWIN MIKROSYSTEM CORP., Taichung City (TW)

(72) Inventors: Huang-Ming LIN, Taichung City (TW); Ruei-Bin HSIAO, Taichung City (TW)

(21) Appl. No.: 15/389,713

(22) Filed: Dec. 23, 2016

(51) Int. Cl. H02G 15/007; F16B 2/06; H01B 7/18

(52) U.S. Cl. CPC H02G 15/007; H01B 7/1805; F16B 2/06

(57) ABSTRACT

The present invention provides a cable fixture, where a hole with a varying inner diameter is disposed on a body, the body is used as a connection site for engaging the cable fixture with an external mechanical device, and the hole is used for a line to pass through so that after the inner diameter of the hole is reduced, the line passing through the hole is tightened, so as to achieve an effect of positioning the line.

### BACKGROUND OF THE INVENTION

### Field of the Invention

The present invention relates to line positioning technology, and more particularly to a cable fixture.

### Description of the Related Art

The use of cables for wired transmission of power or signals is still a commonly used transmission means in various industrial fields for the purpose of ensuring the stability of the transmission of the power or the signals and avoiding damage to transmission lines. However, in a connection between a flexible transmission line and a connected mechanical device, if the transmission line is not appropriately positioned, friction due to repeated movement may easily cause damage to a protection layer of the transmission line, thereby deriving a security risk. Therefore, in order to avoid abrasion due to repeated relative movement between the transmission line and the mechanical device, in the prior art, a pipe joint is provided between the transmission line and the connected mechanical device, so as to provide an effect of positioning the transmission line and the mechanical device to avoid relative movement there-between, thereby achieving protection of the transmission line.

Although the prior art disclosed earlier can achieve the expected effect of positioning and protection, conventionally, the engagement between the pipe joint and the mechanical device is accomplished mainly by screwing a screw into a screw hole. Therefore, when a screw hole for a pipe joint to engaged in cannot be drilled on a mechanism device to be engaged, an intermediary stationary rack needs to be additionally used for connection, causing inconvenience of assembly and processing as well as an excessively large overall height, and resulting in potential interference with other mechanical devices and increased difficulty of installation in industrial application.

### SUMMARY OF THE INVENTION

Therefore, a main objective of the present invention is to provide a cable fixture, which has a simple structure, so as to prevent from occupying an excessively high space in use and to position a line at a position that is close to a line outgoing site as far as possible.

Accordingly, in order to achieve the foregoing objective, the present invention provides a cable fixture, where a hole with a varying inner diameter is disposed on a body, the body is used as a connection site for engaging the cable fixture with an external mechanical device, and the hole is used for a line to pass through so that after the inner diameter of the hole is reduced, the line passing through the hole is tightened, so as to achieve an effect of positioning the line.

In addition to the body and the hole, the specific technical content of the present invention further includes a variable space, a screw hole, and an adjusting member, where the body has a first chamber wall and a second chamber wall corresponding to each other. The hole with a varying inner diameter is disposed on the body. The variable space is configured between the first chamber wall and the second chamber wall, and communicated with the hole to weaken the strength of the body. The screw hole is disposed in the body and configured on the first chamber wall. The adjusting member is disposed on the body and spans between the first chamber wall and the second chamber wall to be screwed into the screw hole. A pulling force is applied by the adjusting member to enable the first chamber wall and the second chamber wall to get close to each other, so that the inner diameter of the hole is reduced by reducing a distance between the first chamber wall and the second chamber wall.

The variable space may assume a slot shape or a hole shape, which is sufficient to achieve an effect of destructing the existing strength of a partial site of the body, so as to reduce the pulling force that the adjusting member needs to provide.

Moreover, the weakening of the strength of the body by the variable space may further be achieved by extending the variable space to a side end of the body to form an opening.

The cable fixture further includes a through hole, which is disposed in the body and extends coaxially with the screw hole from the second chamber wall. Then, the adjusting member passes through the through hole and is screwed into the screw hole.

Further, for different line outgoing directions of line bodies, the hole does not necessarily extend along a straight line, and may be disposed in the body along a curved extension path. In other words, not only the hole may be disposed between two opposite side ends of the body, but also the hole may be disposed between two adjacent side ends of the body, which depends on requirements of actual use.

In addition, in order to enable the engagement of the body and an external mechanical device to be easily implemented, the cable fixture may further include an engaging portion, disposed at one side, corresponding to the space, of the body.

The engaging portion has at least one engaging hole, extending through the body.

### BRIEF DESCRIPTION OF THE DRAWINGS

FIG. 1 is a top perspective view according to a first embodiment of the present invention.

FIG. 2 is a bottom perspective view according to the first embodiment of the present invention.

FIG. 3 is a sectional view along a direction 3-3 of FIG. 1 according to the first embodiment of the present invention.

FIG. 4 is a schematic plan view according to the first embodiment of the present invention.

FIG. 5 is a side perspective view according to a second embodiment of the present invention.

FIG. 6 is a bottom perspective view according to the second embodiment of the present invention.

FIG. 7 is a bottom perspective view according to a third embodiment of the present invention.

FIG. 8 is a schematic plan view according to the third embodiment of the present invention.

FIG. 9 is a top perspective view according to a fourth embodiment of the present invention.

FIG. 10 is a schematic plan view according to the fourth embodiment of the present invention.

FIG. 11 is a top perspective view according to a fifth embodiment of the present invention.

FIG. 12 is a schematic plan view according to the fifth embodiment of the present invention.

FIG. 13 is a top perspective view according to a sixth embodiment of the present invention.

FIG. 14 is a schematic plan view according to the sixth embodiment of the present invention.

### DETAILED DESCRIPTION OF THE PREFERRED EMBODIMENTS

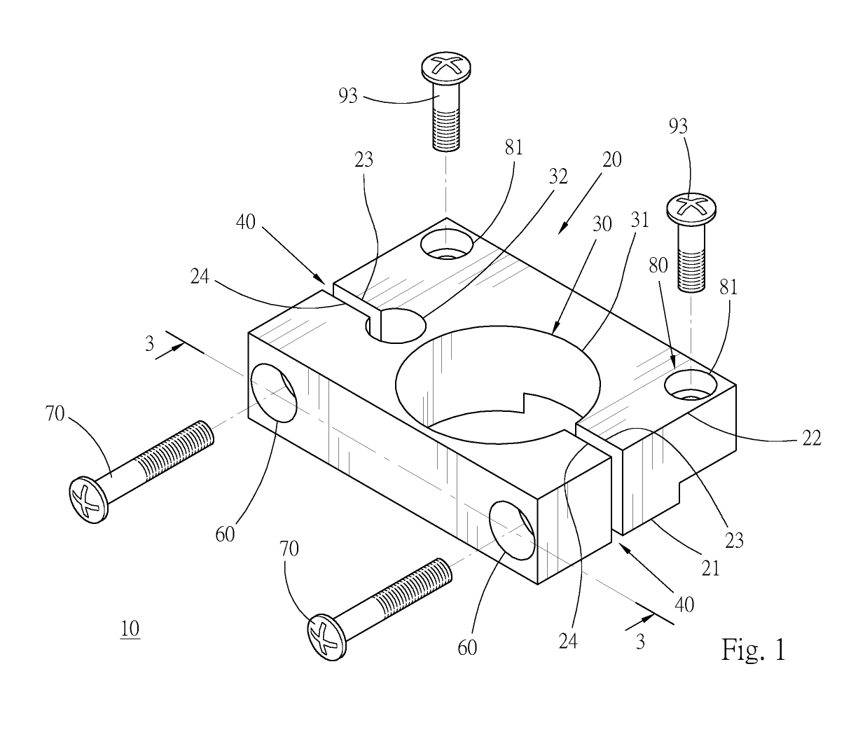

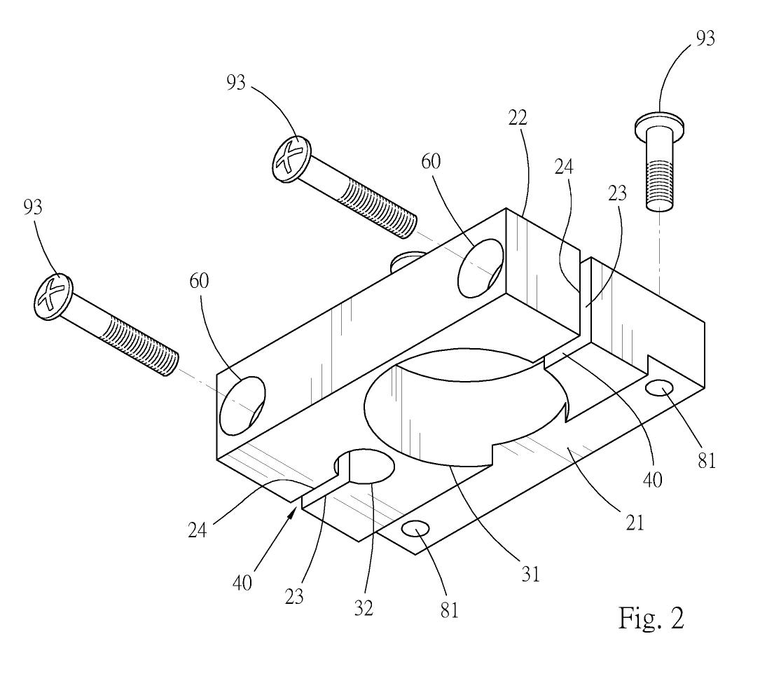

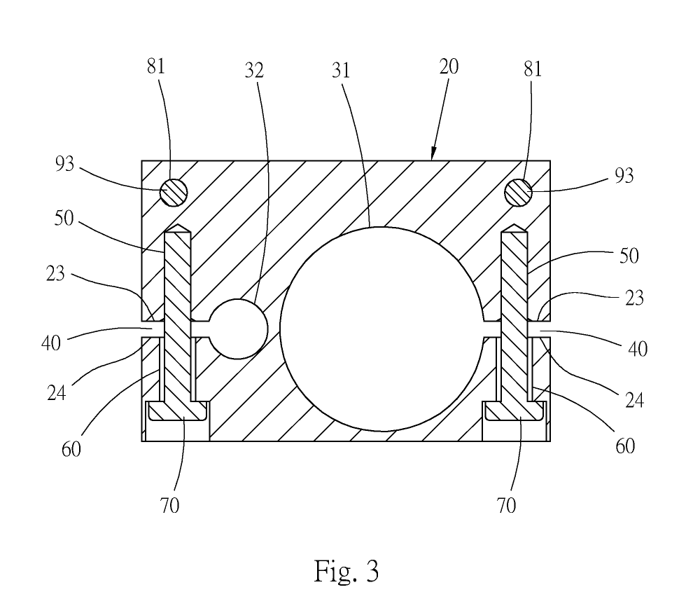

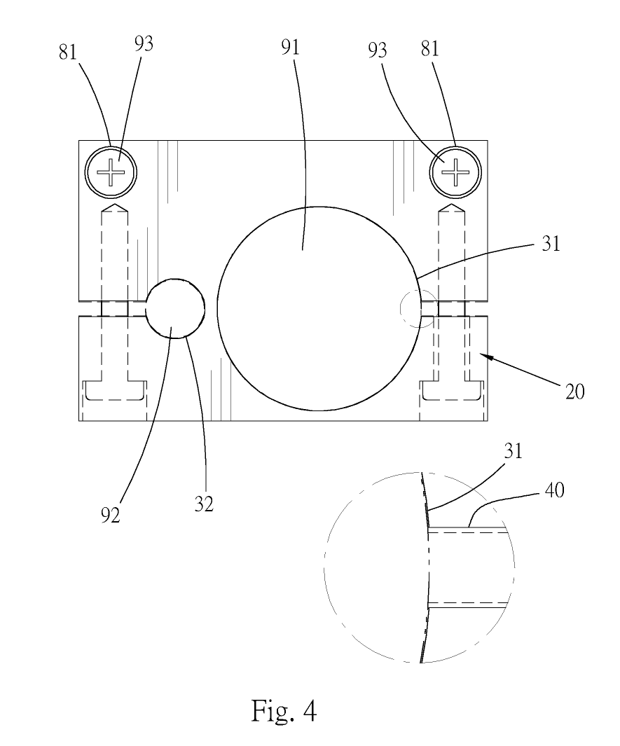

First, referring to FIG. 1 to FIG. 4, a cable fixture (10) provided in a first embodiment of the present invention mainly includes a body (20), a hole (30), variable spaces (40), screw holes (50), through holes (60), adjusting members (70), and an engaging portion (80).

The body (20) is a block-shaped metal body, and has a generally flat bottom end surface (21), so as to ensure that the body (20) is suitably attached to a line outgoing site of a power line or a signal line in a mechanical device such as a motor or a platform, thereby achieving stable support.

The hole (30) has a first perforation (31) and a second perforation (32) with different inner diameters, which are respectively disposed on the body (20) parallel to each other, and extend between the bottom end surface (21) and a top end surface (22) of the body (20) that are opposite to each other.

The two variable spaces (40) each assume an elongated hole shape, so as to weaken the strength of the parts of the body (20) that correspond to the first perforation (31) and the second perforation (32), and to enable the inner diameters of the first perforation (31) and the second perforation (32) to be reduced in the presence of an external force. The variable spaces (40) respectively configure between the top end surface (22) and the bottom end surface (21) of the body (20), one end of one variable space (40) and one end of the other variable space (40) respectively extend to a left side end and a right side end of the body (20) to form openings, and the other end of the one variable space (40) and the other end of the other variable space (40) are respectively in communication with adjacent ones of the first perforation (31) and the second perforation (32) in radial directions of the holes. Two first chamber walls (23) and two second chamber walls (24) are disposed on the body (20), and are essentially hole walls of the respective variable spaces (40) at two sides.

The two screw holes (50) are disposed in the body (20) and extend perpendicularly inwardly from the first chamber walls (23) respectively.

The two through holes (60) extend perpendicularly from the second chamber walls (24) to corresponding sides of the body (20), coaxially with the screw holes (50), respectively.

The two adjusting members (70) respectively pass through the through holes (80), and are screwed into the corresponding coaxial screw holes (50). As such, by changing the screwing depths of the adjusting members (70) and the screw holes (50), the distances between the first chamber walls (23) and the second chamber walls (24) facing each other are changed, so as to change the inner diameters of the corresponding variable spaces (40), thereby changing the inner diameter of the hole (30).

The engaging portion (80) is used for securing the body (20) to a surface of an object to which the body (20) is attached, and is provided with a plurality of engaging holes (81) that extends between the top end surface (22) and the bottom end surface (21) of the body (20), so that the body (20) can be securely disposed on the surface of the object to which the body (20) is attached, through the engaging portion (80) by conventional connection means such as screws. It should be particularly noted herein that it is suitable to arrange the engaging portion (80) and the through holes (60) at different sides of the variable spaces (40), thereby avoiding interference with reduction of the inner diameter of the hole (30) by the adjusting members (70).

By means of the constitution of the foregoing components, a part of the bottom end surface (21) having a step of the body (20) of the cable fixture (10) is attached to peripheries of line outgoing sites of line bodies such as a power line (91) and a signal line (92) in a mechanical device such as a motor or a platform, and then is securely connected to the peripheries of the line outgoing parts by extending conventional engaging means such as screws (93) through the engaging holes (81), so that the cable fixture (10) is appropriately positioned. As such, the power line (91) may be passed through the first perforation (31) and the signal line (92) may be passed through the second perforation (32). Further, by rotating the adjusting members (70), screwing depths of the adjusting members (70) and the screw holes (50) are adjusted, such that the effect of reducing the inner diameters of the first perforation (31) and the second perforation (32) respectively is achieved, so as to tighten the power line (91) and the signal line (92) passing through the first perforation (31) and the second perforation (32) respectively, thereby achieving the positioning effects.

As compared with the prior art, in the cable fixture (10), the technical content that the inner diameters of the first perforation (31) and the second perforation (32) can vary is combined on the body (20) assuming a block shape, which not only substantially reduces the overall volume, but also presents a single object structure so as to facilitate the manufacture and assembly, which is hardly reachable by the prior art and achieves the significant effect.

In addition to the disclosure of the foregoing first embodiment, variations made to partial structures under the technical features of the present invention may lead to a different usage effect, for example, there are still various other different embodiments that may be disclosed. For example, the number of the spaces for line bodies to pass through that are formed by a hole may be one, in addition to a plurality of the spaces disclosed above. Also, an extension direction of a hole may be set according to a second embodiment shown in FIG. 5 and FIG. 6. That is, a perforation of a hole (30a) is in communication with a bottom end surface (21a) of a body (20a) and an adjacent side end, so as to form an L-shaped turn space, so that a line may extend out from the side end after entering from the bottom end of the body (20a), thereby achieving an effect of changing a line outgoing direction; further, in order to facilitate an operator to turn the line, the hole (30a) may be provided with an opening (301a) that is formed on a top end surface (22a) of the body (20a), so as to provide an operation space for the operator.

Furthermore, in order to reduce a force that an adjusting member needs to apply when narrowing a hole, further weakening the strength of a body is a feasible approach. Therefore, in the second embodiment, a variable space (40a) is disposed on the bottom end surface (21a) of the body (20a), and a weakening groove (41a) in communication with the hole (30a) is further recessed, such that the inner diameter of the hole (30a) can be changed by an adjusting member (70a) in a relatively effortless manner.

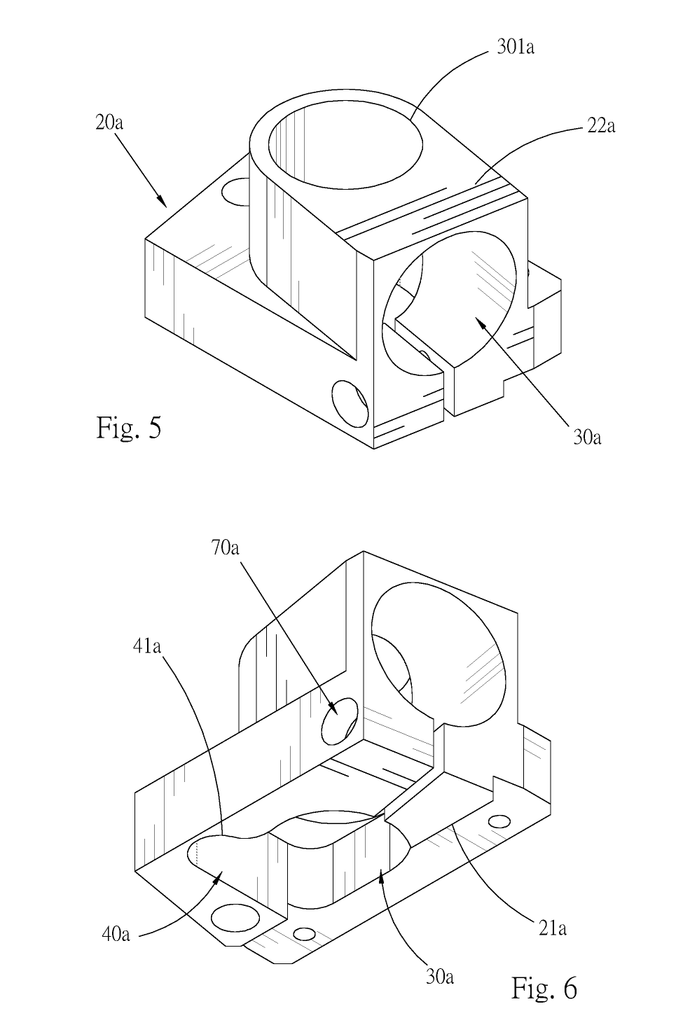

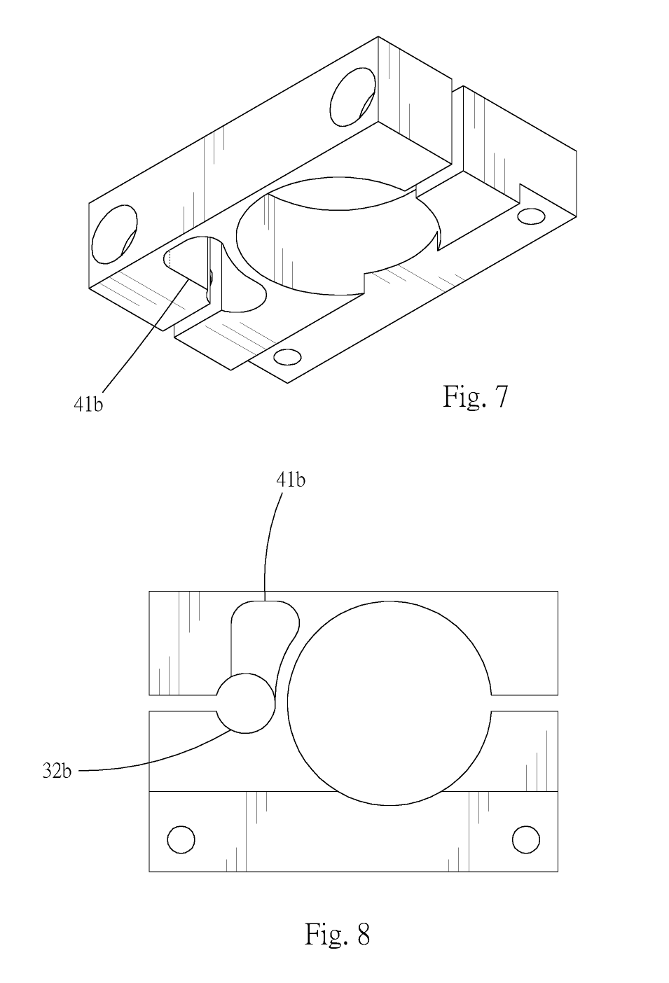

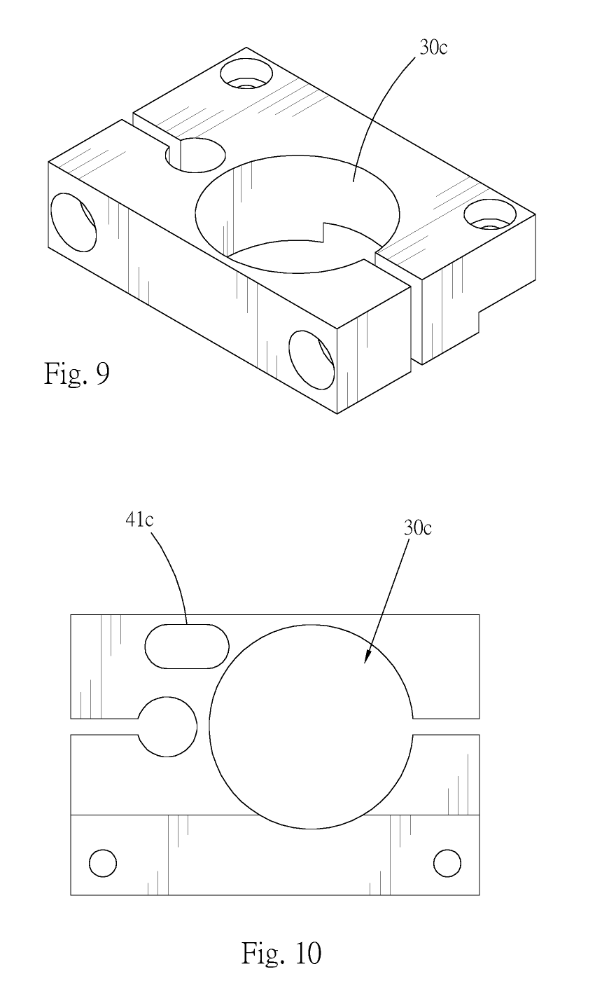

Moreover, the shape and the spatial position of the weakening groove may also be those as disclosed in a third embodiment shown in FIG. 7 and FIG. 8, where a weakening groove (41b) is in communication with a second perforation (32b), or may also be those as disclosed in a fourth embodiment as shown in FIG. 9 and FIG. 10, where a weakening groove (45c) is disposed independently of a hole (30c) and is not in communication with the hole (30c).

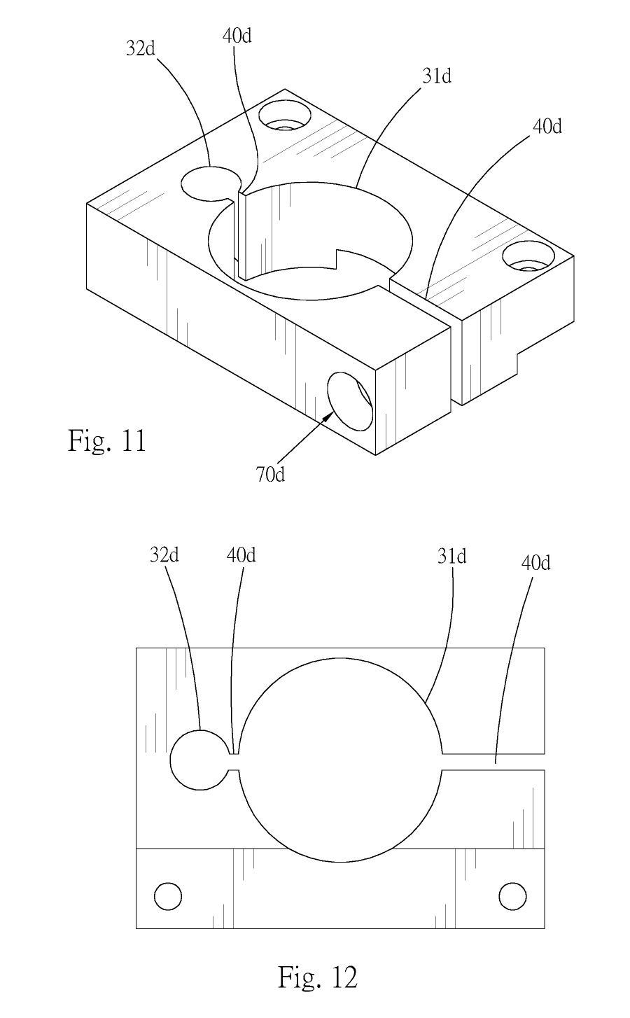

Further referring to FIG. 11 and FIG. 12, in a fifth embodiment of the present invention, one of two variable spaces (40d) is disposed between a first perforation (31d) and a second perforation (32d), and therefore, the first perforation (31d) and the second perforation (32d) are in communication with each other, so that the sizes of the first perforation (31d) and the second perforation (32d) can be synchronously reduced only with a single adjusting member (70d).

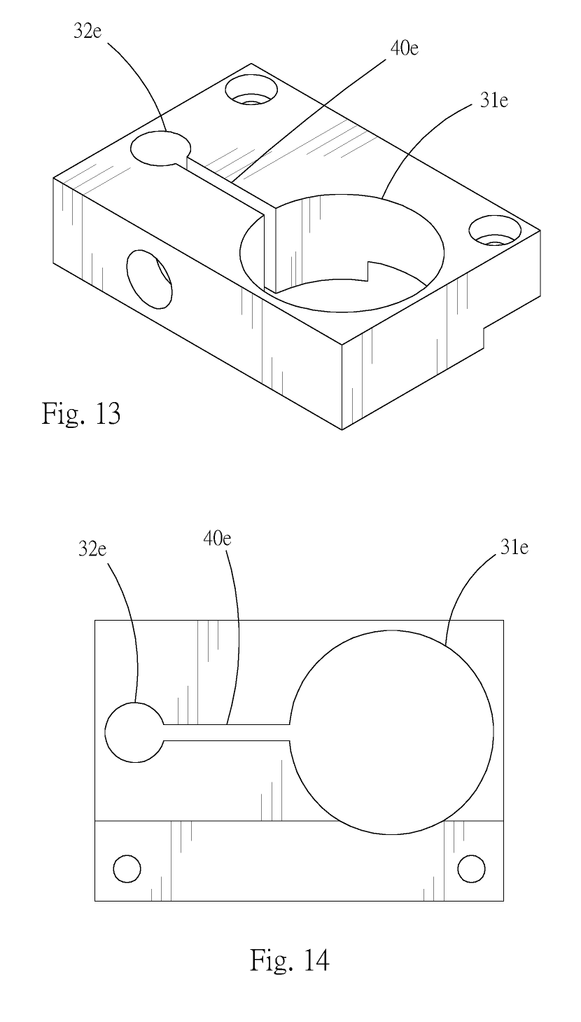

Similarly, a sixth embodiment shown in FIG. 13 and FIG. 14 is provided. By comparison, the sixth embodiment differs from the fifth embodiment in that the number of a variable space (40e) is further reduced to one, and the variable space (40e) is located between a first perforation (31e) and a second perforation (32e).

Although the foregoing embodiments are different in partial structures, the technical features thereof are the same, and there is no significant difference in effects. Therefore, the foregoing embodiments all fall within the scope of the technical features of the present invention, and should be equally protected.

1. A cable fixture, comprising:
a body, having a first chamber wall and a second chamber wall corresponding to each other;
a hole with a varying inner diameter, disposed on the body;
a variable space, configured between the first chamber wall and the second chamber wall, and communicated with the hole to weaken a strength of the body;
a screw hole, configured on the first chamber wall; and
an adjusting member, disposed on the body and spanning between the first chamber wall and the second chamber wall to be screwed into the screw hole, by which a pulling force is applied to enable the first chamber wall and the second chamber wall to get close to each other, so that the inner diameter of the hole is reduced when a distance between the first chamber wall and the second chamber wall is reduced.

2. The cable fixture according to claim 1, wherein the variable space assumes a slot shape.

3. The cable fixture according to claim 1, wherein the variable space assumes an elongated hole shape.

4. The cable fixture according to claim 1, wherein the variable space extends to a side end of the body so as to form an opening.

5. The cable fixture according to claim 1, further comprising a through hole, disposed in the body and extending coaxially with the screw hole from the second chamber wall.

6. The cable fixture according to claim 5, wherein the adjusting member passes through the through hole and is screwed into the screw hole.

7. The cable fixture according to claim 1, wherein the hole is disposed between two opposite side ends of the body.

8. The cable fixture according to claim 1, wherein the hole is disposed between two adjacent side ends of the body.

9. The cable fixture according to claim 1, further comprising an engaging portion, disposed at one side, corresponding to the variable space, of the body.

10. The cable fixture according to claim 9, wherein the engaging portion has at least one engaging hole, extending through the body.
